(19) United States
(12) Patent Application Publication
(10) Pub. No.: US 2002/0068784 A1
(43) Pub. Date: Jun. 6, 2002

(54) Tire tread comprising a styrene/butadiene emulsion copolymer

(76) Inventor: Roland Rauline, Durtol (FR)

Correspondence Address: BAKER & BOTTS, 30 ROCKEFELLER PLAZA, NEW YORK, NY, 10112

(21) Appl. No.: 09/968,308

(22) Filed: Oct. 1, 2001

Related U.S. Application Data
(63) Continuation of application No. PCT/EP01/00918, filed on Jan. 29, 2001.

(30) Foreign Application Priority Data
Feb. 2, 2000 (FR) 00/01339

(51) Int. Cl. C08J 3/28

(52) U.S. Cl. 524/492; 152/209.1; 522/160; 525/333.3

(57) ABSTRACT

The present invention relates to a tire tread comprising a crosslinkable rubber composition which comprises at least one emulsion copolymer of styrene and butadiene and to a process for improving the wear resistance of such a tread. The invention applies to a tread comprising a majority proportion of a reinforcing white filler as reinforcing filler. A tire tread according to the invention includes a crosslinkable rubber composition which comprises at least one elastomeric emulsion copolymer of styrene and butadiene and a reinforcing filler having a major proportion thereof being a reinforcing white filler. The reinforcing white filler is present in the composition in a quantity of greater than or equal to 40 phr. This composition is such that the copolymer comprises an emulsifier in an amount ranging from 1 to 3.5 phr (parts by weight per 100 parts of the elastomeric copolymer).

### BACKGROUND OF THE INVENTION

The present application is a continuation of PCT/EP 01/00918, filed Jan. 29, 2001 now WO 01/56812. The present invention relates to a tire tread comprising a crosslinkable rubber composition, wherein the composition comprises at least one emulsion copolymer of styrene and butadiene, and to a process for improving the wear resistance of such a tread. The invention applies to a tread wherein the major proportion of reinforcing filler comprises a reinforcing white filler.

It is known that rubber compositions for tire treads include copolymers of styrene and butadiene (referred to herein as “SBR” in the remainder of the present description) alone or associated with other elastomers, depending upon the desired properties.

SBRs are most frequently prepared in an emulsion, i.e. by associating an emulsifier with the monomers in an aqueous medium. This emulsifier fulfils three main functions:

to produce a stable and well dispersed emulsion of the monomers,

to solubilize the monomers within micelles, wherein said monomers will be more accessible to free radicals, and

to prevent precipitation of the copolymer formed.

The presently used emulsifiers are primarily fatty acid soaps, such as soaps of capric, lauric, myristic, palmitic, stearic or oleic acid. Alternatively, soaps of resin acids (also known as resin soaps or rosin soaps), such as soaps of acids of the abietic or hydroabietic type, for example of tetrahydroabietic acid, are used as emulsifiers.

Synthetic emulsifiers, such as aryl sulphate, sodium lauryl sulphonate or cumene peroxide, may also be used.

There are two major types of emulsion copolymerization processes for styrene and butadiene. The high temperature process (performed at a temperature of about 50° C.) is suitable for preparing highly branched SBRs, while the low temperature process (performed at a temperature ranging from about 15° C. to 40° C.), allows the production of more linear SBRs.

A detailed description of the effectiveness of several emulsifiers usable in the high temperature process (as a function of the amounts of the emulsifiers) may be found in two articles by C. W. Carr, I. M. Kolthoff, E. J. Meehan, University of Minnesota, Minneapolis, Minn., which were published in Journal of Polymer Science, 1950, Vol. V, no. 2, pp. 201-206, and 1951, Vol. VI, no. 1, pp. 73-81, respectively.

Comparative examples of the performance of the low temperature process may be found in “Industrial and Engineering Chemistry, 1948, Vol. 40, no. 5, pp. 932-937, E. J. Vandenberg, G. E. Hulse, Hercules Powder Company, Wilmington, Del.” and “Industrial and Engineering Chemistry, 1954, Vol. 46, no. 5, pp. 1065-1073, J. R. Miller, H. E. Diem, B. F. Goodrich Chemical Co., Akron, Ohio”.

In general, a higher concentration of emulsifier in the monomer mixture results in a higher rate of copolymerization, which continues until a monomer conversion approaching that relating to completion of the reaction is reached. Moreover, an increase in emulsifier concentration gives rise to an SBR which imparts still further improved “uncured adhesion” (i.e. the ability to adhere in the unvulcanized state to other unvulcanized rubber compositions) to the rubber composition into which it is incorporated.

However, the presence of an excess of emulsifier, i.e. typically in a concentration of greater than 8 phr (parts by weight per 100 parts of elastomer), makes it difficult to extract the copolymer without degrading the macrostructure thereof and to recover unreacted monomers, due to the presence of foam formed by excess emulsifier in the aqueous phase. This excess emulsifier also imparts mediocre physical properties to a vulcanized rubber composition comprising the SBR prepared in this manner.

Conversely, a low emulsifier concentration in the monomer mixture, typically a concentration below 4 phr, results in a considerably reduced rate of polymerization. For example, Japanese patent document JP-A-82/53 544 discloses the use of SBRs prepared in an emulsion with a reduced emulsifier content (less than or equal to 3 phr) for reducing the rolling resistance of tire treads which contain them.

It is for this reason that commercially available emulsion SBRs are characterized by an emulsifier concentration which is conventionally between 4 and 8 phr.

The person skilled in the art knows that emulsion SBRs are well suited to use in the unvulcanized state.

SBRs may also be prepared in solution by anionic polymerization in a hydrocarbon solvent, the reaction being performed by means of a lithiated initiator. When reinforced with a filler such as silica, the SBRs prepared in this manner exhibit physical properties in the vulcanized state and resistance to wear which are satisfactory.

However, a major disadvantage of conventional emulsion SBRs is the elevated hysteresis exhibited by tire tread compositions comprising these SBRs in comparison with those comprising solution SBRs. A further disadvantage of these conventional emulsion SBRs is the unsatisfactory wear resistance exhibited by rubber compositions containing the emulsion SBRs and reinforcing white filler, such as silica, as reinforcing filler.

### SUMMARY OF THE INVENTION

The object of the present invention is to provide a tire tread having improved wear resistance which includes a crosslinkable rubber composition, wherein the composition comprises at least one elastomeric emulsion copolymer of styrene and butadiene and a reinforcing filler, the major proportion of which is a reinforcing white filler (i.e. in a mass fraction of greater than 50%), in such a manner that said reinforcing white filler is present in said composition in a quantity of greater than or equal to 40 phr.

It has now been discovered that an emulsion SBR prepared in such a manner that it contains an emulsifier content ranging from 1 to 3.5 phr may advantageously be used in a crosslinkable rubber composition comprising a reinforcing filler as defined above. The rubber composition considerably improves the wear resistance of a tire tread comprising the composition when compared to a tread containing a conventional emulsion SBR copolymer, without impairing and possibly even improving other physical properties in the vulcanized state, in particular hysteresis properties.

The copolymers of styrene and butadiene which may be used in the present invention may be prepared using either a high temperature process or a low temperature process. The reinforcing white filler is preferably present in the composition in an amount of greater than or equal to 60 phr, more preferably in an amount ranging from 70 phr to 100 phr.

### DETAILED DESCRIPTION OF THE INVENTION

In the present invention, “reinforcing white filler” means a “white” filler (i.e. an inorganic filler, in particular a mineral filler), sometimes also called “clear” filler, which is capable, on its own, without any means other than an intermediate coupling system, of reinforcing a rubber composition intended for the manufacture of tires. The reinforcing white filler is capable of replacing a conventional filler of tire-grade carbon black in its reinforcement function.

Preferably, all or at least a major proportion of the reinforcing white filler is silica (SiO₂). The silica used may be any reinforcing silica known to the person skilled in the art, in particular any precipitated or pyrogenic silica having a BET surface area and a specific CTAB surface area both of which are less than 450 m²/g. Highly dispersible precipitated silicas are preferred, in particular when the invention is used to manufacture tires having a low rolling resistance.

The BET specific surface area is determined in accordance with the known method of Brunauer, Emmett and Teller described in “The Journal of the American Chemical Society”, vol. 60, page 309, February, 1938, which corresponds to Standard AFNOR-NFT-45007 (November, 1987); the CTAB specific surface area is the external surface area determined in accordance with the same Standard AFNOR-NFT-45007 of November, 1987.

“Highly dispersible silica” is intended to mean any silica having a very substantial ability to disagglomerate and to disperse in an elastomeric matrix, which can be observed in known manner by electron or optical microscopy on thin sections. Non-limiting examples of such preferred highly dispersible silicas include silica Perkasil KS 430 from Akzo, silica BV 3380 from Degussa, silicas Zeosil 1165 MP and 1115 MP from Rhodia, silica Hi-Sil 2000 from PPG, silicas Zeopol 8741 or 8745 from Huber, and treated precipitated silicas, such as the aluminium-“doped” silicas described in application EP-A-0 735 088.

Additionally, the reinforcing white filler may also include

aluminas (of formula Al₂O₃), such as aluminas of high dispersibility as described in European Patent Specification EP-A-810 258, or alternatively

aluminium hydroxides, such as those described in International Patent Application WO-A-99/28376.

The physical state of the reinforcing white filler may be in the form of a powder, microbeads, granules or balls. “Reinforcing white filler” is also intended to mean mixtures of different reinforcing white fillers, in particular of highly dispersible silicas such as described above.

The reinforcing white filler may also be used in a blend (mixture) with carbon black. Suitable carbon blacks are any carbon blacks, in particular the blacks of the type HAF, ISAF and SAF, which are conventionally used in tires, particularly in tire treads. Non-limiting examples of such blacks include the blacks N115, N134, N234, N339, N347, N358, N375. The amount of carbon black present in the total reinforcing filler may vary within wide limits, with the amount preferably being less than the amount of reinforcing white filler present in the rubber composition.

For example, black/silica blends or blacks partially or entirely covered with silica are suitable to form the reinforcing filler. Also suitable are carbon blacks modified by silica, for example, the fillers described in European Patent Application EP-A-711 805 and those sold by CABOT under the name “CRX 2000”, which are described in International Patent Application WO-A-96/37547.

Where the reinforcing filler comprises a reinforcing white filler and carbon black, the mass fraction of carbon black in the reinforcing filler is preferably less than or equal to 30% of the total filler.

The rubber composition according to the invention further comprises a reinforcing white filler/elastomeric matrix bonding agent (also referred to as coupling agent), the function of which is to ensure sufficient chemical and/or physical bonding (or coupling) between the white filler and the matrix, while facilitating the dispersion of the white filler within the matrix.

Such a bonding agent, which is at least bifunctional, has the simplified general formula “Y-T-X”, in which:

Y represents a functional group (“Y” function) which is capable of bonding physically and/or chemically with the white filler, such bond being established, for example, between a silicon atom of the coupling agent and hydroxyl (OH) surface groups of the filler (for example, surface silanols in the case of silica);

X represents a functional group (“X” function) which is capable of bonding physically and/or chemically with the elastomer, for example via a sulfur atom; and

T represents a hydrocarbon group that links Y and X.

These bonding agents are not to be confused with simple agents for covering the filler in question which comprise the Y function which is active with respect to the filler, but are devoid of the X function which is active with respect to the elastomer.

Bonding agents, of variable effectiveness, have been described in a large number of documents and are well-known to the person skilled in the art. In fact, it is possible to use any bonding agent known to or likely to provide an effective bond between a silica and a diene elastomer in diene rubber compositions used in the manufacture of tires, such as organosilanes, in particular polysulfurized alkoxysilanes or mercaptosilanes, or polyorganosiloxanes bearing the X and Y functions mentioned above.

The bonding agent used in the rubber compositions according to the invention is a polysulfurized alkoxysilane which bears the “Y” and “X” functions, which can be grafted on the white filler by means of the “Y” function (alkoxysilyl function) and on the elastomer by means of the “X” function (sulfur function). Polysulfurized alkoxysilanes, such as those described in U.S. Pat. Nos. 3,842,111; 3,873,489; 3,978,103; 3,997,581; 5,580,919; 5,583,245; 5,663,396; 5,684,171; 5,684,172 and 5,696,197 may be used in the present invention.

Preferably, the polysulfurized alkoxysilane is a polysulphide, particularly a tetrasulphide, of bis(alkoxy(C₁-C₄)silylpropyl), more preferably of bis(trialkoxy(C₁-C₄)silylpropyl), in particular of bis(3-triethoxysilylpropyl) or of bis(3-trimethoxysilylpropyl).

A particularly preferred bonding agent is bis(triethoxysilylpropyl) tetrasulphide, or TESPT, of the formula [(C₂H₅O)₃Si(CH₂)₃S₂]₂, which is sold by Degussa under the name “Si69” (or X50S when it is supported to 50% by weight on carbon black) or under the name “Si75” (disulphide) or, alternatively, by Witco under the name “Silquest A1289”.

The content of polysulfurized alkoxysilane lies within a range of 0.5 to 15% relative to the weight of reinforcing white filler in the rubber compositions of the invention.

In addition to the elastomeric matrix, the reinforcing filler and one or more reinforcing white filler/elastomer bonding agent(s), the tire tread compositions of the invention contain all or part of the other constituents and additives usually used in rubber mixtures, such as plasticizers, pigments, antioxidants, antiozone waxes, a vulcanization system based either on sulfur and/or peroxide and/or bismaleimides, vulcanization accelerators, extender oils, and optionally one or more agents for coating the reinforcing white filler, such as alkoxysilanes, polyols, amines etc.

It will be noted that the tread composition according to the invention may comprise a blend of one or more emulsion SBRs in a total mass fraction (of the composition) ranging from 50 to 100%, each SBR comprising an emulsifier in an amount of 1 to 3.5 phr, and one or more essentially unsaturated diene elastomers in a total mass fraction ranging from 50 to 0%.

As used herein, “diene” elastomer or rubber means an elastomer resulting at least in part (i.e. a homopolymer or a copolymer) from diene monomers (monomers bearing two double carbon-carbon bonds, whether conjugated or not). As used herein, “essentially unsaturated” diene elastomer means a diene elastomer resulting at least in part from conjugated diene monomers, having a content of members or units of diene origin (conjugated dienes) which is greater than 15% (mol %).

Within the category of “essentially unsaturated” diene elastomers, a “highly unsaturated” diene elastomer means a diene elastomer having a content of units of diene origin (conjugated dienes) which is greater than 50%, such as:

any homopolymer obtained by polymerization of a conjugated diene monomer having 4 to 12 carbon atoms;

any copolymer obtained by copolymerization of one or more dienes conjugated together or with one or more vinylaromatic compounds having 8 to 20 carbon atoms.

Suitable conjugated dienes include 1,3-butadiene, 2-methyl-1,3-butadiene, 2,3-di(C1 to C5 alkyl)-1,3-butadienes such as, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene.

Suitable vinylaromatic compounds include styrene, ortho-, meta- and para-methylstyrene, the commercial mixture “vinyltoluene”, para-tert.-butylstyrene, methoxystyrenes, chlorostyrenes, vinylmesitylene, divinylbenzene and vinylnaphthalene.

The copolymers may contain between 99% and 20% by weight of units resulting from diene monomers and between 1% and 80% by weight of units resulting from vinylaromatic monomers. The elastomers may have any microstructure, which is a function of the polymerization conditions used, in particular of the presence or absence of a modifying and/or randomizing agent and the quantities of modifying and/or randomizing agent used. The elastomers may for example be block, random, sequenced or microsequenced elastomers, and may be prepared in a dispersion or in solution. They may be coupled and/or starred or alternatively functionalized with a coupling and/or starring or functionalizing agent.

Preferred diene elastomers include polybutadienes, in particular those having a content of 1,2-units of between 4% and 80%, or those having a cis-1,4 content of more than 80%; polyisoprenes; butadiene-styrene copolymers, in particular those having a styrene content of between 5% and 50% by weight, more particularly, between 20% and 40%, a content of 1,2-bonds of the butadiene part of between 4% and 65%, and a content of trans-1,4 bonds of between 20% and 80%; butadiene-isoprene copolymers, in particular those having an isoprene content of between 5% and 90% by weight and a glass transition temperature (Tg) of between −40° C. and −80° C.; and isoprene-styrene copolymers, in particular those having a styrene content of between 5% and 50% by weight and a Tg of between −25° C. and −50° C.

Suitable butadiene-styrene-isoprene copolymers include those having a styrene content of between 5% and 50% by weight, more particularly, between 10% and 40%, an isoprene content of between 15% and 60% by weight, more particularly between 20% and 50%, a butadiene content of between 5% and 50% by weight, more particularly between 20% and 40%, a content of 1,2-units of the butadiene part of between 4% and 85%, a content of trans-1,4 units of the butadiene part of between 6% and 80%, a content of 1,2- plus 3,4-units of the isoprene part of between 5% and 70%, and a content of trans-1,4 units of the isoprene part of between 10% and 50%, and more generally any butadiene-styrene-isoprene copolymer having a Tg of between −20° C. and −70° C.

Preferably, the diene elastomer of the composition according to the invention is selected from the group of highly unsaturated diene elastomers which includes polybutadienes (BR), polyisoprenes (IR), butadiene-styrene copolymers (SBR), butadiene-isoprene copolymers (BIR), isoprene-styrene copolymers (SIR), butadiene-styrene-isoprene copolymers (SBIR), and mixtures of two or more of these compounds.

Preferably, a tire tread according to the invention is such that the copolymer comprises the emulsifier in an amount ranging from 1 to 2 phr.

According to another feature of the invention, the emulsifier comprises at least one resin acid and/or at least one fatty acid, in particular oleic acid.

According to another feature of the invention, the copolymer exhibits a content of trans linkages which is greater than or equal to 70% and a content of styrene linkages that ranges from 20% to 45%.

Furthermore, the number average molecular weight of the copolymer ranges from 110,000 g/mol to 140,000 g/mol.

A tire according to the invention comprises a tread as defined above.

The aforementioned features of the present invention, as well as others, will be better understood on reading the following description of several examples of embodiment of the invention, which are given by way of illustration and not of limitation, in comparison with “control” examples illustrating the prior art.

In these examples, the properties of the rubber compositions are evaluated as follows:

Mooney viscosity ML(1+4) at 100° C.: measured in accordance with ASTM:D-1646, hereinafter abbreviated to ML;

modulus of elongation at 100% (M100): measurements taken in accordance with Standard ISO 37,

Shore A hardness: measurements made in accordance with Standard DIN 53505,

dynamic shear properties (G*): measurements as a function of the deformation, performed at 10 Hertz with a peak-to-peak deformation from 0.15% to 50%.

Hysteresis is expressed by the measurement of tan delta at 7% deformation and at 40° C. in accordance with Standard ASTM D2231-71 (reapproved in 1977).

I. Examples of Elastomers Intended for use in a Tread According to the Invention, Compared to “Control” Elastomers

In these examples, testing was performed:

two elastomers according to the invention, E-SBR A and E-SBR B, each being an emulsion copolymer of styrene and butadiene, prepared in a manner known per se, that have an emulsifier content of 1.7 phr and 1.2 phr, respectively, and

two “control” elastomers, E-SBR C and E-SBR D (sold by BAYER under the names “KRYNOL 1712” and “KRYNOL 1721” respectively), each an emulsion copolymer of styrene and butadiene having an emulsifier content of 5.7 phr and 4.5 phr, respectively.

Table I below summarizes the essential characteristics of each of the four elastomers tested with regard to microstructure, properties, formulation and macrostructure.

Microstructure was determined in accordance with Standard ISO 6287.

Emulsifier content was determined in accordance with Standard ISO 1407 (for the quantity of acetone extract) and in accordance with Standard ASTM D297 (for non-saponifiable content).

Furthermore, the quantities of fatty acids and of fatty and resin acid soaps were determined in accordance with Standard ISO 7781.

TABLE I

| | | | |
|---|---|---|---|
| E-SBR A | E-SBR B | E-SBR C | E-SBR D |

MICROSTRUCTURE

| | | | | |
|---|---|---|---|---|
| 1,2 linkages | 14.8 | 13.6 | 14.9 | 14.2 |
| (in %) | | | | |
| 1,4 linkages | 12.4 | 12.8 | 13.0 | 14.2 |
| (in %) | | | | |
| Trans linkages | 72.8 | 73.6 | 72.1 | 71.6 |
| (in %) | | | | |
| Styrene linkages | 23.1% | 40.9 | 23.9 | 38.3 |
| (%) | | | | |

PROPERTIES & CONSTITUENTS

| | | | | |
|---|---|---|---|---|
| Tg | −51 | −31 | −53 | −36 |
| Mooney viscosity | 64 | 50 | 46 | 54.5 |
| ML(1 + 4) | | | | |
| Density | 0.942 | 0.969 | 0.947 | 0.967 |
| Emulsifier (phr) | 1.7 | 1.2 | 5.7 | 4.5 |
| Fatty acids | 14.8 | 15.4 | 169 | 166 |
| (mEq/kg) | | | | |
| Fatty & resin acid | 14.1 | 11.3 | 18.3 | 17.5 |
| soaps (mEq/kg) | | | | |
| Oil content (phr) | 38.5 | 38.1 | 38.1 | 37.9 |

MACROSTRUCTURE

| | | | | |
|---|---|---|---|---|
| Mn (g/mol) | 129,648 | 113,197 | 119,397 | 135,210 |
| Mw (g/mol) | 650,012 | 635,940 | 621,216 | 623,703 |
| Polydispersity Ip | 5.014 | 5.618 | 5.203 | 4.613 |

E-SBR A and E-SBR B of the invention each exhibit a microstructure similar to that of the “controls” E-SBR C and E-SBR D.

It may also be concluded that E-SBR A and E-SBR B of the invention each have:

a fatty acid content (essentially stearic and palmitic acid) which is less than one tenth of that of the “controls” E-SBR C and E-SBR D, and

a soap content which is reduced by approximately 25% relative to that of the “controls” E-SBR C and E-SBR D.

Analysis was performed to identify the compounds present in the ethereal phase of each of these elastomers obtained from a dry toluene/ethanol extract. Mass spectrometry was used for this purpose.

1) Analytical Method

The dry extracts corresponding to the ethereal phases were redissolved in dichloromethane, then esterified with tetramethylammonium hydroxide.

The resultant solutions were analyzed by combining gas phase chromatography and mass spectrometry techniques.

a) Mass spectrometry

The following equipment and parameters were used:

“HP MSD5973” spectrometer;

electron impact ionization;

a scanned range of masses: 33 to 550 amu;

1300 V multiplier.

b) Gas phase chromatography

The following equipment and parameters were used:

“HP 6890” chromatograph;

“INNOWAX” column characterized by a length of 30 m, a diameter of 0.25 mm, a phase consisting of polyethylene glycol and a film thickness of 0.15 μm;

carrier gas consisting of helium;

“split” injection;

injector temperature of 250° C.;

the following temperature program:

T1=50° C.

D1=2 min

P1=15° C./min.

T2=250° C.

Interface temperature=280° C.

2) Results

The principal products identified, grouped together under the headword “emulsifier”, are as follows:

For E-SBR A

TMQ monomer (polymerized 2,2,4-trimethyl-1,2-dihydroquinoline) 6PPD (N-(1,3-dimethylbutyl)-N′-phenyl-p-phenylenediamine) oleic acid.

For E-SBR B

TMQ monomer

6PPD

oleic acid.

For E-SBR C

palmitic acid

6PPD

stearic acid

oleic acid.

For E-SBR D

myristic acid (14 carbon atoms)

palmitic acid

6PPD

stearic acid

oleic acid.

It may be concluded from these analyses that the copolymers E-SBR A and E-SBR B according to the invention comprise oleic acid, but neither palmitic nor stearic acid. In addition, they comprise TMQ monomer, not found in the “control” copolymers E-SBR C and E-SBR D.

II. Use of “Control” Elastomers and Elastomers According to the Invention E-SBR A and E-SBR B in a Tread Comprising Silica as Majority Reinforcing Filler

Testing was performed on:

a tread composition according to the invention which comprises a blend of elastomers E-SBR A and E-SBR B in comparison with:

a first “control” tread composition \mathring{1} comprising a blend of S-SBR prepared in solution and a high-cis polybutadiene (BR), and

a second “control” tread composition \mathring{2} comprising a blend of “control” emulsion elastomers E-SBR C and E-SBR D.

More specifically, the polybutadiene is characterized by a cis-1,4 linkage content of approximately 93% and is obtained, for example, by the process described in French Patent Specification FR-A-1 436 607.

The essential characteristics of the S-SBRs are as follows.

1,2 content (%) 58

styrene content (%) 25

trans content (%) 23

extender oil (phr) 37.5

Tg (° C.) −29

Mooney ML(1+4) 54.

1) Formulation and Properties of the Rubber Compositions

Table II below shows the formulation of each of the above-stated rubber compositions and processing properties (in the unvulcanized state) and physical properties (in the vulcanized state) obtained for each formulation.

TABLE II

| | | |
|---|---|---|
| Comp. of the | | |
| invention | Comp. \mathring{1} | Comp. \mathring{2} |

FORMULATION (in phr)

| | | | |
|---|---|---|---|
| E-SBR A | 68.75 | | |
| E-SBR B | 68.75 | | |
| E-SBR C | | | 68.75 |
| E-SBR D | | | 68.75 |
| S-SBR | | 110 | |
| BR | | 20 | |
| Black N234 | 7 | 7 | 7 |
| Silica “1165 MP” | 85 | 85 | 85 |
| (Rhodia) | | | |
| Silane/DPG | 6.8/1.6 | 6.8/1.6 | 6.8/1.6 |
| bonding agent | | | |
| High viscosity | | 5 | |
| aromatic oil | | | |
| ZnO/stearic acid | 2.5/2 | 2.5/2 | 2.5/2 |
| 6PPD/ozone wax | 1.9/1.5 | 1.9/1.5 | 1.9/1.5 |
| Sulfur/CBS | 1.2/1.9 | 1.2/1.9 | 1.2/1.9 |

PROPERTIES (measured on profiles)

| | | | |
|---|---|---|---|
| ML (1 + 4) | 106 | 119 | 85 |
| Shore A | 68.5 | 68.7 | 69.6 |
| M100 | 1.77 | 1.97 | 1.83 |

Table II shows that the elastomers E-SBR A and E-SBR B impart processing properties to the rubber composition according to the invention which are similar to those imparted by the S-SBR to the corresponding “control” composition \mathring{1}.

Table II also shows that the rigidity in the vulcanized state of the composition according to the invention is similar to that of the “control” composition \mathring{2} based on conventional emulsion SBRs.

Table III below shows the viscoelastic properties of these rubber compositions.

TABLE III

| | Comp. of the | | |
|---|---|---|---|
| | invention | Comp. \mathring{1} | Comp. \mathring{2} |
| G* at 10% and | 2.50 | 2.40 | 2.80 |
| at 40° C. | | | |
| tgδ at 7% and | 0.285 | 0.285 | 0.330 |
| at 40° C. | | | |

Table III shows that the elastomers E-SBR A and E-SBR B impart reduced hysteresis to the rubber composition according to the invention relative to that imparted by “control” composition \mathring{2} based on conventional emulsion SBRs (tgδ at 7% deformation).

2) Rolling Wear Resistance Tests for Treads Consisting of these Rubber Compositions

Wear resistance testing was performed on a model “MXT” tire of dimensions 175/70 R14 with a tread according to the invention and on tires of the same dimensions and model comprising treads corresponding to “controls” \mathring{1} and \mathring{2}.

Wear resistance values were determined by means of a relative wear index calculated on the basis of remaining rubber depth after driving on a winding road circuit until wear reaches the wear indicators arranged in the grooves of the treads.

This relative wear index was obtained by comparing the remaining rubber depths of the E-SBR-based treads (i.e. treads \mathring{2} and treads according to the invention) with the remaining rubber depths of the S-SBR-based treads (i.e. treads \mathring{1}), reference baseline of 100 being assigned to this latter remaining rubber depth.

A relative wear index of greater than this baseline of 100 indicates improved wear resistance relative to said tread \mathring{1}.

The wear results are set out in Table IV below.

TABLE IV

| | Tread of the | Tread \mathring{1} | |
|---|---|---|---|
| | invention | (reference) | Tread \mathring{2} |
| Relative wear index | 100 | 100 | 80 |

In the light of this Table, it would seem that the wear resistance of the tread according to the invention is 20% better than that of a tread comprising E-SBRs having an emulsifier content of greater than 4 phr, such as tread \mathring{2}, and is similar to that of tread \mathring{1} comprising an S-SBR prepared in solution.

It will be noted that this improvement in wear resistance is essentially due to the reduced emulsifier content in the tread composition according to the invention, relative to composition \mathring{2}.

Consequently, it may be concluded from these examples that, according to the invention, the use of an emulsion SBR having an emulsifier content of between 1 and 3.5 phr in a tire tread composition brings about a substantial improvement in the wear resistance of the composition and reduces the hysteresis losses thereof, relative to a tread composition comprising a conventional emulsion SBR having an emulsifier content of greater than 4 phr without there being any degradation of other properties in the vulcanized state.

I claim:

1. Tire tread comprising a crosslinkable rubber composition which composition comprises an elastomeric emulsion copolymer of styrene and butadiene and a reinforcing filler, wherein a major proportion of the filler is a reinforcing white filler, said reinforcing white filler being present in the composition in an amount of greater than or equal to 40 phr, wherein the copolymer comprises an emulsifier in an amount ranging from 1 to 3.5 phr (parts by weight per 100 parts of the elastomeric copolymer).

2. Tire tread according to claim 1, wherein copolymer comprises the emulsifier in an amount ranging from 1 to 2 phr.

3. Tire tread according to claim 1, wherein the emulsifier comprises a resin acid and/or a fatty acid.

4. Tire tread according to claim 1, wherein the copolymer has a trans linkage content which is greater than or equal to 70%.

5. Tire tread according to claim 1, wherein the copolymer has a styrene linkage content which ranges from 20% to 45%.

6. Tire tread according to claim 1, wherein the copolymer has a number average molecular weight ranging from 110,000 g/mol to 140,000 g/mol.

7. Tire tread according to claim 1, wherein the reinforcing filler comprises silica.

8. Tire tread according to claim 7, wherein the reinforcing filler comprises a blend of silica and carbon black.

9. Tire tread according to claim 7, wherein the reinforcing filler comprises carbon black surface-modified by silica.

10. A tire comprising the tread according to claim 1.

11. A method for manufacturing a tire tread having improved wear resistance comprising incorporating into the tire tread a cross-linkable rubber composition which composition comprises an elastomeric emulsion copolymer of styrene and butadiene and a reinforcing filler, the major proportion of which comprises an elastomeric emulsion copolymer of styrene and butadiene and a reinforcing filler, wherein a major proportion of the filler is a reinforcing white filler, said reinforcing white filler being present in the composition in an amount of greater than or equal to 40 phr, wherein the copolymer comprises an emulsifier in an amount ranging from 1 to 3.5 phr (parts by weight per 100 parts of the elastomeric copolymer), and vulcanizing the composition to provide a tire tread having improved wear resistance.
